(19) United States
(12) Patent Application Publication
(10) Pub. No.: US 2017/0171325 A1
(43) Pub. Date: Jun. 15, 2017

(54) Method and System for Using Timestamps and Algorithms Across Email and Social Networks to Identify Optimal Delivery Times for an Electronic Personal Message

(71) Applicant: Paul Andrew Perez, Signal Mountain, TN (US)

(72) Inventor: Paul Andrew Perez, Signal Mountain, TN (US)

(21) Appl. No.: 14/964,039

(22) Filed: Dec. 9, 2015

(51) Int. Cl. H04L 29/08; H04L 12/26; H04L 12/58

(52) U.S. Cl. CPC H04L 67/22; H04L 51/32; H04L 51/22; H04L 67/10; H04L 43/106

(57) ABSTRACT

The present invention is a computer-implemented method of, and system for, determining optimal delivery time of an electronic personal message. As used herein “optimal delivery time” means the time or time slot when the recipient of the message is most likely to open it and click through it. This is accomplished by obtaining, from the communication networks used by the intended message recipients, network timestamp data, such as historical log-in and log-out information, and processing the data in a way that yields one or more optimal future delivery times for each individual recipient.

### CROSS-REFERENCE TO RELATED APPLICATIONS

Continuation of U.S. patent application Ser. No. 13/944,215

### STATEMENT REGARDING FEDERALLY SPONSORED RESEARCH OR DEVELOPMENT

Not applicable

### REFERENCE TO SEQUENCE LISTING, TABLE, COMPUTER PROGRAM LISTINGS OR COMPACT DISC APPENDIX

Not applicable

### BACKGROUND OF THE INVENTION

Internet usage and email usage are prevalent worldwide and continuing to grow apace. According to most estimates, as of 2013 there were between 2.2 and 2.4 billion unique internet users worldwide. A majority of these users have email accounts. According to the Radicati Group, as of 2012, there were an estimated 3.3 billion email accounts worldwide. About 75% of these email accounts belong to individuals, and the remainder belong to businesses. In 2012 world email traffic was estimated at almost 145 billion messages daily. The Radicati Group estimates that by 2016 world email traffic will exceed 190 billion messages daily.

Use of social media has also grown explosively. As of July 2013, Facebook was estimated to have 1.11 billion accounts, Twitter was estimated to have 500 million accounts, Instagram was estimated to have 130 million accounts, and Tumblr was estimated to have almost 109 million accounts. Furthermore as of July 2013, Youtube was estimated to have approximately 1 billion users viewing approximately 4 billion videos per day.

Email is an asynchronous form of communication, and so are most applications of social media. From a technical standpoint, asynchronous communication involves a physical layer transmission technique in which the sender's clock and recipient's clock are independent of one another. From a user standpoint, asynchronous simply means that a conversation takes place intermittently over time: a message is sent to a recipient who may not know about the message until hours or days later and may wait even longer to respond. Instant messaging is synchronous but online social network status updates are asynchronous.

The standard in asynchronous communications networks is to buffer or queue messages until the recipient can read them. Messages placed onto the queue are stored until the recipient retrieves them. The sender and receiver of the message do not need to interact with the message queue at the same time Message queues have implicit or explicit limits on the size of data that may be transmitted in a single message and the number of messages that may remain outstanding on the queue.

Email clients and servers have for some time facilitated “read receipts.” Typically a read receipt takes the form of an email notification delivered to the sender when a recipient opens, and presumably reads, an email. The receipt confirms that the recipient saw the message and records the time. However, requesting a receipt does not guarantee that one will be received, for several reasons. Not all email applications or services support read receipts, and users can generally disable the functionality if they so wish. Services or applications that do support it are not necessarily compatible with or capable of recognizing requests from a different email service or application. Generally, read receipts are only useful within an organization where all employees/members are using the same email service and application.

There are other ways of tracking email besides the use of read receipts. Some email marketing tools include tracking as a feature. Such email tracking is usually accomplished using standard web tracking devices such as cookies or web beacons. When a tracked email message is sent in graphical hypertext markup language (HTML) message format, the email marketing tool may embed a tiny, invisible tracking image, called a web beacon, within the content of the message. When the recipient opens the message, the tracking image is referenced. When the recipient clicks a link or opens an attachment, another tracking code is activated. In each case a separate tracking event is recorded by the system. These response events accumulate over time in a database and enable the email marketing software to report metrics such as open-rate and click-through rates. Email marketing users can view reports on both aggregate response statistics and individual response over time.

In general, email sent as part of a commercial marketing campaign suffers from relatively low open and click-through rates. “Open rate” is usually defined as the number opened messages divided by the number of delivered messages. The number of delivered messages is always less than the number of sent messages, and “delivery rate” is defined as the number of delivered messages divided by the number of sent messages. “Click-through rate” is usually defined as the number of clicks on messages divided by the number of delivered messages.

Reasons for low open and click-through rates on email marketing campaigns are numerous and varied, but probably center around the limits of the human attention span and email fatigue on the part of the recipients. Because email is an asynchronous communication mode, several dozen messages might queue up between recipient log-ins. The more that messages accumulate in the in-box, the less likely it is that every message will be opened, much less read or clicked on. This principle holds true for messages from non-profit foundations just as well as messages from commercial marketers.

Good communicators have historically understood that “timing is everything”, whether it be sending a promotion for a consumer product on the first of the month when many people receive their monthly paycheck, or not sending a promotion for a business product on a weekend when most people are out of their office.

Accordingly, it would be advantageous to provide a method of improving the open and click-through rates for electronic message campaigns of all types. With this in mind, the present inventor hypothesized that recipients of electronic messages would be more likely to open them and click through them if the recipients were actually logged into the communication network of interest at the time of receiving the message. The premise behind the present invention is simply that a recipient is more likely to open and click-through an electronic message if that message is received while the recipient is logged-in and active on a communication network, as compared with the message arriving when the recipient is not logged-in and the message gradually descending to the bottom of a message queue as subsequent messages arrive and are queued.

To test the hypothesis, the present inventor built out a single-network prediction/send technology platform. In 2009 the platform was made public for beta testing at http://www.cross-reference.us. The first communication network tested was that of Facebook. Subsequently Twitter was added as a second communication network, and the test platform was broadened to conduct prediction of optimal send times across multiple communication networks as well as to distribute the sending across networks. The present inventor has found that each user has a preference about their connection to various networks, and these connection preferences are taken into consideration when recommending a time to send a message to that user.

The present inventor integrated with commercial email service provider ExactTarget to test the efficacy of the present invention on multiple case study email campaigns involving several million email addresses and several tens of millions of data points. In every case study, a significant improvement in open rate and click-through rate were observed versus the control group. In some case studies the open rate and click-through rate were more than doubled.

This invention predicts when a message should be sent, via one or more communication networks, based on the recipients' actual history of using their computer or other internet access device on those networks or another network, and subsequently transmits the message at the predicted time or provides for such transmission.

### BRIEF SUMMARY OF THE INVENTION

The present invention is a computer-implemented method of, and system for, determining optimal delivery time of an electronic personal message. As used herein “optimal delivery time” means the time or time slot when the recipient of the message is most likely to open it and click through it. This is accomplished by obtaining, from the communication networks used by the intended message recipients, network timestamp data, such as historical log-in and log-out information, and processing the data in a way that yields one or more optimal future delivery times for each individual recipient.

In a preferred embodiment of the invention, the network timestamp data is obtained by placing an application programming interface (API) call to the administrator of a communication network. The network may be, but is not limited to, an email service provider (ESP) or a social media network. The raw data is then compiled into a database that can be processed through an algorithm to determine optimal delivery times; the algorithm does this by identifying one or more historical time-slots of maximal network activity for each user of the network. The algorithm may be, but is not limited to, a wavelet transform model, a Poisson generalized linear regression model, or a Markov model. The database may comprise raw data collected for the same user, or recipient, across multiple networks.

In another preferred embodiment of the invention, the algorithm assigns a multiplier to primary time-slots of historical maximum user activity on the network, assigns a smaller multiplier to adjoining secondary time-slots on either side of the primary time-slots, and sums the products of the respective multipliers and time-slots to determine future times when a network user is most likely to be logged in, and therefore most likely to open and click through any electronic messages received.

In yet another preferred embodiment of the invention a second algorithm is used to schedule the sending of an electronic personal message to individual members of a communication network at future times when they are most likely to be logged-in to the network.

In another embodiment, the invention includes the use of a third algorithm in detecting whether one or more members of a communication network are logged-in currently, and if they are logged in, immediately sending them an electronic personal message.

In an additional embodiment of the invention, an API call is placed to the administrator of a communication network to obtain and process, using a fourth algorithm, open and click-through data for the messages sent to members of the network, to determine whether open and click-through rates have indeed been enhanced.

The present invention also embodies a system for accomplishing the method, described herein, of delivering an electronic personal message at the optimal times for enhancing likelihood of open and click-through of the message. The system comprises a computing device that includes an optimal delivery-time application and a database.

The foregoing and other features of the present invention are hereinafter fully described and particularly pointed out in the claims. The following description and the annexed drawings set forth in detail one or more illustrative aspects of the invention, such being indicative, however, of but one or a few of the various ways in which the principles of the invention may be employed.

### BRIEF DESCRIPTION OF THE DRAWINGS

The drawings disclose exemplary embodiments exhibiting only various objectives and features of the present invention.

FIG. 1 illustrates an exemplary computing device that may be used according to exemplary embodiments of the present invention.

FIG. 2 shows an alternative operating environment for a mobile device substantially for use in the present invention.

FIG. 3 provides a schematic of an exemplary presence database.

FIG. 4 provides a flow chart of an exemplary method for practicing the present invention.

### DETAILED DESCRIPTION OF THE INVENTION

The present invention is now described more fully hereinafter with reference to the accompanying drawings, which form a part hereof, and which show, by way of illustration, specific exemplary

embodiments for practicing the invention. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

### Illustrative Operating Environment

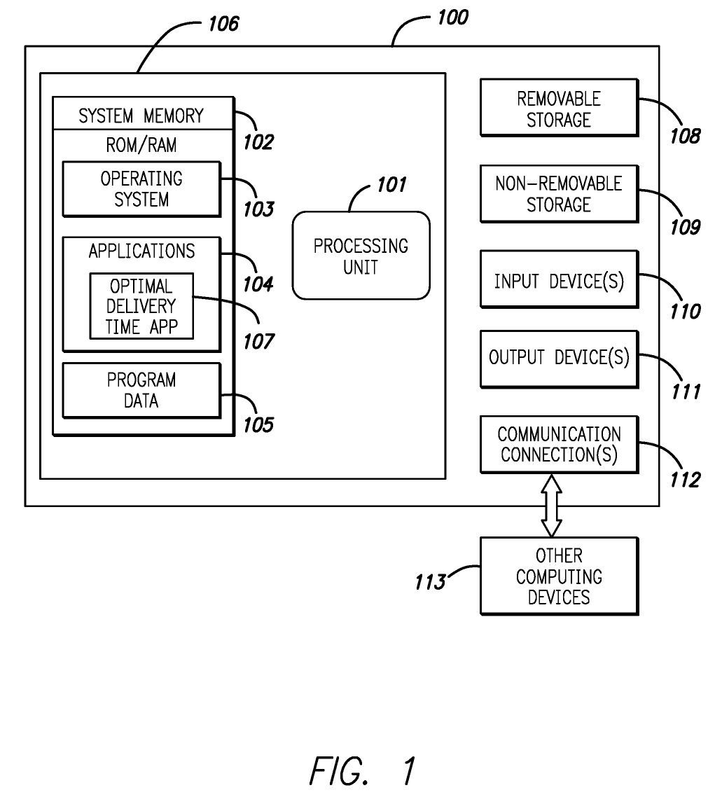

One exemplary system for implementing the invention includes a computing device, such as computing device 100, as seen in FIG. 1. Computing device 100 may be configured as a client, a server, a mobile device, or any other computing device that provides for interacting with communications networks, storing a database, executing algorithms, detecting network user presence and enabling a web user interface (WUI). In a very basic configuration, computing device 100 typically includes at least one processing unit 101 and system memory 102. Depending on the exact configuration and type of computing device, system memory 102 may be volatile (such as random access memory or RAM), non-volatile (such as read only memory or ROM, flash memory and the like) or some combination of the two. System memory 102 typically includes an operating system 103, one or more applications 104, and may include program data 105. Typically, applications 104 include an application 107 for using timestamps and algorithms across email and social networks to identify optimal delivery times of one or more electronic messages. This basic configuration is illustrated in FIG. 1 by those components within solid boundary line 106.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 108 and non-removable storage 109. Computer storage media may include volatile and nonvolatile, removable and non-removable media implemented in any method or technology for storage of information, such as computer readable instructions, data structures, program modules, or other data. System memory 102, removable storage 108 and non-removable storage 109 are all examples of computer storage media. Computer storage media includes, but is not limited to, RAM, ROM, electrically erasable programmable read-only memory or EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 110 such as keyboard, mouse, pen, voice input device, touch input device, or the like. Output device(s) 111 such as a display, speakers, printer or the like may also be included.

Computing device 100 also contains communication connections 112 that allow the device to communicate with other computing devices 113, such as over a network.

Communication connection 112 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency or RF, infrared and other wireless media. The term computer readable media as used herein includes both storage media and communication media.

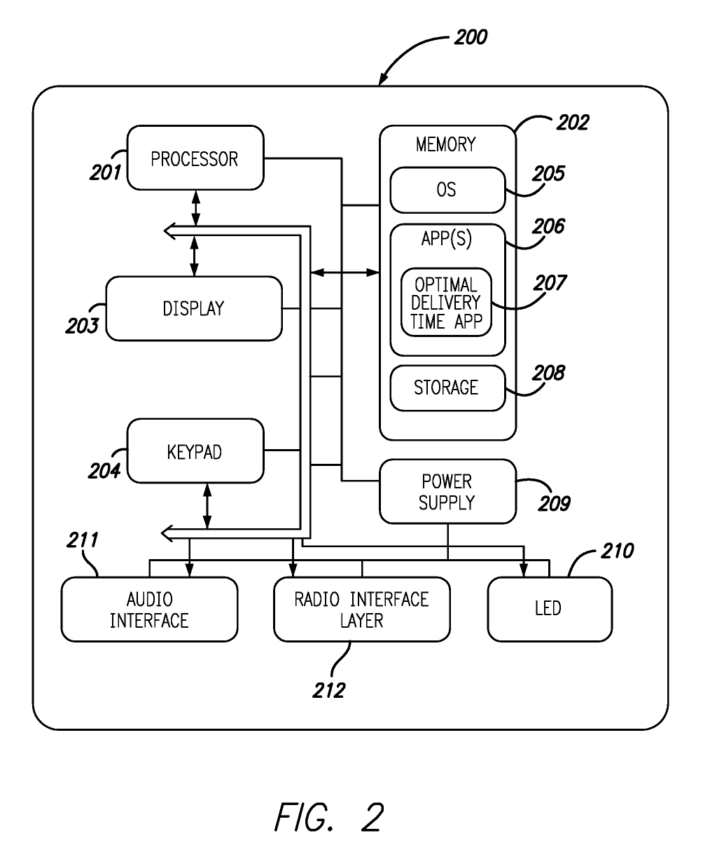

FIG. 2 shows an alternative operating environment for a mobile device substantially for use in the present invention. In one embodiment of the present invention, mobile device 200 is integrated as a computing device, such as an integrated personal digital assistant (PDA) and wireless phone, or “smartphone.”

In this embodiment, mobile device 200 has a processor 201, a memory 202, a display 203, and a keypad 204. Memory 202 generally includes both volatile memory (e.g. RAM) and non-volatile memory (e.g. ROM, flash memory, or the like). Mobile device 200 includes an operating system 205, which is resident in memory 202 and executes on processor 201. Keypad 204 may be a push button numeric dialing pad (such as on a typical telephone), a multi-key keyboard (such as a conventional keyboard), or may not be included in the mobile device in deference to a touch screen or stylus. Display 203 may be a liquid crystal display (LCD), light emitting diode display (LED) or any other type of display commonly used in mobile computing devices. Display 203 may be touch-sensitive, and would then also act as an input device.

One or more application programs 206 are loaded into memory 202 and run on operating system 205. Examples of application programs include phone dialer programs, email programs, scheduling programs, personal information management (PIM) programs, word processing programs, spreadsheet programs, internet browser programs, and the like. Typically, application programs 206 include an application 207 for using timestamps and algorithms across email and social networks to identify optimal delivery times of one or more electronic messages. Mobile device 200 also includes non-volatile storage 208 within the memory 202. Non-volatile storage 208 may be used to store persistent information which should not be lost if mobile device 200 is powered down. The applications 206 may use and store information in storage 208, such as email or other messages used by an email application, contact information used by a PIM, appointment information used by a scheduling program, documents used by a word processing application, and the like. A synchronization application also resides on the mobile device and is programmed to interact with a corresponding synchronization application resident on a host computer to keep the information stored in the storage 208 synchronized with corresponding information stored at the host computer.

Mobile device 200 has a power supply 209, which may be implemented as one or more batteries. Power supply 209 might further include an external power source, such as an AC adapter or a powered docking cradle that supplements or recharges the batteries.

Mobile device 200 is also shown with two types of external notification mechanisms: an LED 210 and an audio interface 211. These devices may be directly coupled to power supply 209 so that when activated, they remain on for a duration dictated by the notification mechanism even though processor 201 and other components might shut down to conserve battery power. LED 210 may be programmed to remain on indefinitely until the user takes action to indicate the powered-on status of the device. Audio interface 211 is used to provide audible signals to and receive audible signals from the user. For example, audio interface 211 may be coupled to a speaker for providing audible output and to a microphone for receiving audible input, such as to facilitate a telephone conversation.

Mobile device 200 also includes a radio 212 that performs the function of transmitting and receiving radio frequency communications. Radio 212 facilitates wireless connectivity between the mobile device 200 and the outside world, via a communications carrier or service provider. Transmissions to and from the radio 212 are conducted under control of the operating system 205. In other words, communications received by the radio 212 may be disseminated to application programs 206 via the operating system 205, and vice versa.

The radio 212 allows the mobile device 200 to communicate with other computing devices, such as over a network. The radio 212 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

### Illustrative Method and System

The present invention comprises a computer-implemented method of, and system for, determining optimal delivery time of an electronic personal message. In a preferred embodiment of the invention, a presence database is assembled. The presence database comprises available timestamp data, including but not limited to, log-in and log-out information, open and click information, number of messages posted on social media networks, number of emails sent during an online session, and related data and metadata for an unlimited number of individual members of communication networks.

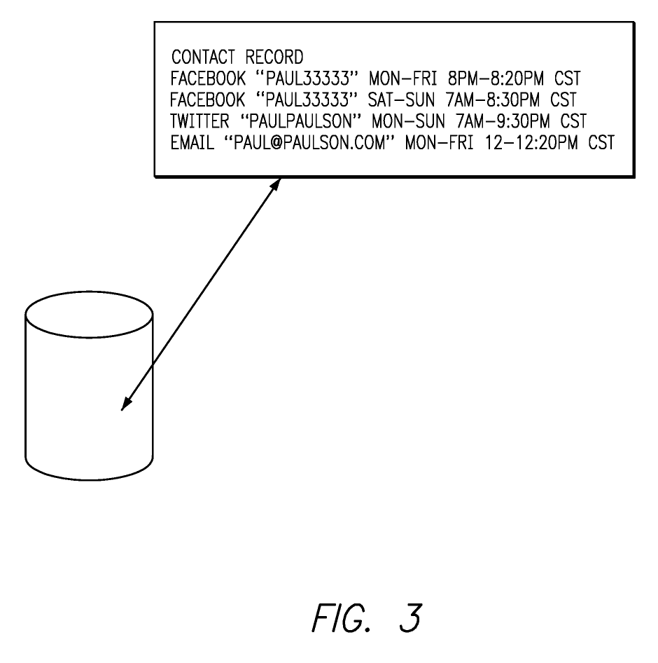

For each individual member of a communications network, information is collected across multiple networks used by the same individual. FIG. 3 provides a schematic of a presence database wherein information has been collected across communication networks for hypothetical individual “Paul Paulson”; his log-in and log-out information for every day of the week is collected for Facebook, Twitter and email. An individual user of communication networks may have different log-in and log-out habits during the week for different communication networks. In FIG. 3, for example, hypothetical user Paul Paulson customarily logs into Facebook briefly in the evenings during the week, but customarily logs into Facebook all day on the weekends. By way of contrast, he logs into Twitter all day every day, and he only checks his @paulson email account briefly during the lunch hour on weekdays.

In a preferred embodiment of the present invention, a presence database comprises all available timestamp information for an unlimited number of users of communications networks, all of whom, or various subsets of whom, may comprise desirable targets for electronic personal messages. The communications networks used in the present invention may be personal mail box or email service providers such as, but not limited to, Yahoo!, Gmail, Hotmail, PoBox, Lycos, AOL Mail, and internet service providers such as, but not limited to, Verizon, Comcast, Cox, Charter, Cablevision, Mediacom and TimeWarner Cable. The communications networks used in the present invention may also comprise commercial email service providers such as, but not limited to, MailChimp, Campaign Monitor, iContact, ConstantContact, VerticalResponse, Network for Good, Emma, WhatCounts, ExactTarget, JangoMail, PredictiveResponse, Bronto, Contactology, YesMail, SendGrid and CheetahMail. Furthermore, the communication networks used in the present invention may be social media networks such as, but not limited to, Bebo, BlackPlanet, Blogster, BuzzNet, CaringBridge, Classmates, delicious, Facebook, Flickr, Fotki, Foursquare, Goodreads, Google+, Instagram, Last.fm, Meetup, Myspace, Orkut, Pandora, Pinterest, RenRen, Spotify, Tumblr, Twitter, Yelp and the like.

The presence database and its accompanying database management system (DBMS) may reside locally on any suitable computing device, such as computing device 100 or mobile device 200, or it may reside in the cloud. As used herein, “cloud” refers to computing resources, both hardware and software, that are available in a remote location and accessible over a network such as the internet. The presence database may be of any suitable type, including but not limited to, object oriented databases and relational databases of the SQL, NoSQL, MySQL and NewSQL variety.

The timestamp data populating the presence database may be obtained by any convenient means, but is preferably obtained by making an application programming interface (API) call to the administrator or operator of the communication network of interest. The type and extent of data available in API libraries varies from one communication network to the next, which is why it is often preferable to collect timestamp data for a particular individual on as many different communication networks used by that individual as possible. Furthermore, it is preferable to collect timestamp data for a particular individual over a multi-day, multi-week or multi-month time period. In general, the accuracy of the present invention is enhanced by collecting as many data points as possible over as long a time span as possible. It is preferable to regularly update the data contained in the presence database for each particular individual, as individual usage patterns may change over time.

The data structure for the presence database can take any suitable format, depending upon the choice of information platform and programming language. By way of illustration, following is one possible data structure configuration for a Microsoft SQL server:

[dbo] [user_touches]
[item_id] [bigint](1,1) NOT NULL,
[service_type_id] [int] NOT NULL,
[network_guid] [varchar](128) NOT NULL,
[title] [varchar](160) NULL,
[link] [varchar](255) NULL,
[description] [nvarchar](1023) NULL,
[pub_date] [datetime] NOT NULL,
[author] [varchar](160) NULL,
[rating] [tinyint] NULL,
[network_user_id] [varchar](128) NULL,
[application_user_id] [int] NOT NULL,
[need_sync] [int] NULL,
[event_type_id] [int] NOT NULL,
[email_campaign_id] [int] NULL,
[user_data_id] [bigint] NULL,
[hours] [tinyint] NULL,
[days] [tinyint] NULL,
[is_tokenized] [tinyint] NOT NULL,
[service_provider_id] [int] NULL,
[application_service_provider_id] [int] NULL,
[PK_user_tou_52020FDD1273C1CD1]

In this data structure example, field name [service_type_id] identifies whether the communication network is an ESP or a social media network, field name [pub_date] identifies the date and time of the event, field name [event_type_id] describes the actual event (e.g. open, click, forward, print, reply, post or comment), field name [user_data_id] describes the network user identification (e.g. email address or social media network username), and field name [service_provider_id] identifies the communication network the data comes from.

To determine an optimal delivery time (ODT) for an electronic personal message, all or some portion of the data contained in the presence database is processed through a purpose-built ODT algorithm. In one embodiment of the invention, a week is divided into 168 one-hour time blocks. Network user activity data is captured across all 168 hours of the week and fed into the presence database. The ODT algorithm is configured such that each one hour time block is multiplied by a primary multiplier, the adjoining hours on either side of the primary time block are multiplied by a secondary multiplier, and the hours adjoining the two secondary hours are multiplied by a tertiary multiplier. As a simple example, suppose that an individual Twitter user tweets two times between 9:00 a.m. and 10:00 a.m., six times between 10:00 a.m. and 11:00 a.m., eight times between 11:00 a.m. and noon, three times between noon and 1:00 p.m., and one time between 1:00 p.m. and 2:00 p.m. Further suppose that the multipliers in the ODT algorithm have been set to 1.0 for the primary time block, 0.8 for the secondary time blocks, and 0.4 for the tertiary time blocks. In this example, the primary time block is the hour between 11:00 a.m. and noon, the secondary time blocks are the hours between 10:00 a.m. and 11:00 a.m. and between noon and 1:00 p.m., and the tertiary time blocks are the hours between 9:00 a.m. and 10:00 a.m. and between 1:00 p.m. and 2:00 p.m. The ODT algorithm multiplies the number of events in each of the five time blocks by the appropriate multiplier, and sums the products. In this simple example, the sum would be as follows:

[2*0.4]+[6*0.8]+[8*1.0]+[3*0.8]+[1*0.4]=0.8+4.8+8.0+2.4+0.4=16.4

All 168 hours of a week can be treated in a similar manner for every individual user of a communication network to yield the time blocks of greatest activity, or “heat”, for every user on every network of interest.

In other preferred embodiments, the tertiary multiplier may be set to zero, resulting in a summation across only the primary and secondary time-slots.

The ODT algorithm of the present invention can be adjusted to compensate for the relative currency of the data being collected and/or compared. In general, the ODT algorithm predicts more accurately with more data inputs. But if data is collected for a particular user on a particular network going back two years, for example, the information collected for the most recent months probably provides better information about the user than information one or two years old. Accordingly, the algorithm can apply a weighting to data points depending on their freshness.

It is contemplated that several general classes of mathematical models, aside from that described above, are suitable for use in constructing the ODT algorithm. Classes of mathematical models that may be useful in calculating optimal delivery time include, but are not limited to, wavelet transform models, Poisson generalized linear regression models, and Markov models.

For a wavelet transform model, the input data would comprise a matrix of nⱼᵢ, where nⱼᵢ is the number of events at i-th weekday and j-th hour for a particular user. These numbers would form 7×24 matrix. The output data would be predicted optimal day and hour for each user. A simple two-dimensional wavelet transform of the matrix with periodic boundary conditions would be calculated, and all high order coefficients outside the specified boundary would be set to zero. The inverse wavelet transform would be calculated, giving the result of a matrix with numbers of event at respective day and hour, thereby describing the behavior of a user. All random events would be removed. Maximal elements in the matrix would predict the optimal time for sending the message to that user. The dimensions of the initial matrix would depend on the granularity of information. For example, if the period is 30 minutes, rather than an hour, the matrix has 7×48 dimensions. If the period is 15 minutes, the matrix has 7×96 dimensions. It is contemplated that several different varieties of wavelets (e.g., Daubechies, Coiflet, Symlet) could be used in a wavelet transform model for the present invention.

For a Poisson generalized linear regression model, the input data would comprise sequences of numbers nⱼᵢ for each weekday, where nⱼᵢ is the number of events at i-th weekday and j-th hour for a particular user. The numbers nⱼᵢ would depend on several factors, such as weekday, hour, month, and number of events in a given time period, and in this case it should be possible to apply a generalized linear regression model. Since numbers nⱼᵢ are integer and nonnegative, it could be supposed that nⱼᵢ has a Poisson distribution with respective parameters ⱼᵢ. The output data would be predicted optimal day and hour for each user. Suppose for example that the factors mentioned above may only influence the distribution of nⱼᵢ through a single linear function called the linear predictor logᵢⱼ=₁x₁+ . . . +ₚxₚ. With this approach different models can be obtained by choosing different factors. The simplest model has only two factors: weekday and hour, e.g. logᵢⱼ=0+₁*ᵢ+₂*ⱼ. Additional factors can be added in similar fashion. Explicit expressions are not available for maximum likelihood estimators ₖ, therefore estimates of parameters must be calculated iteratively. One of the methods is iterative weighted least squares (IWLS). Calculating estimations of ᵢⱼ and consequent probabilities gives a result wherein the biggest probability predicts the best day and hour for sending a message. Finding maximal probabilities is equivalent to find the biggest ᵢⱼ.

For a Markov model, the input data would comprise a sequence of triples (i, j, n), where i=1, . . . , 7, j=0, . . . , 23, and n=0,1. Here the user (or system) is at state (i, j, 1) if the user checks his email on the i-th day and j-th hour, and at state (i, j, 0) if he does not check his email. It is possible to reduce the amount of input data by inputting only triples with n=1. The output data would be predicted optimal day and hour for each user. The states may be enumerated lexicographically as (0,0,0), (0,0,1), (0,1,0), (0,1,1), . . . , and we can denote by pₖₘ the probability that the system will change its state from state k to m. The changes of state of the system are called transitions, and the corresponding probabilities are called transition probabilities. A Markov chain is completely described by states and transition probabilities. In our case transition probabilities form a square matrix with 24*7*2=336 rows. The number of rows is equal to the number of states. It is evident that from state (i, j, l), the j=23 or (i, 23, l) system can jump only into state (i, j+1, s) or (i+1, 0, s) respectively. Therefore most probabilities are equal to zero and the matrix of transition probabilities has the following form:

$$P = ( \begin{matrix}0 & 0 & {a}_{1} & 1 - {a}_{1} & 0 & 0 & … & 0 & 0 & 0 & 0 & 0 & 0 \\ 0 & 0 & {b}_{1} & 1 - {b}_{1} & 0 & 0 & … & 0 & 0 & 0 & 0 & 0 & 0 \\ 0 & 0 & 0 & 0 & {a}_{1} & 1 - {a}_{2} & … & 0 & 0 & 0 & 0 & 0 & 0 \\ 0 & 0 & 0 & 0 & {b}_{2} & 1 - {b}_{2} & … & 0 & 0 & 0 & 0 & 0 & 0 \\ 0 & 0 & 0 & 0 & 0 & 0 & … & 0 & 0 & 0 & 0 & 0 & 0 \\ 0 & 0 & 0 & 0 & 0 & 0 & … & 0 & 0 & 0 & 0 & 0 & 0 \\ ⋮ & ⋮ & ⋮ & ⋮ & ⋮ & ⋮ & ⋱ & ⋮ & ⋮ & ⋮ & ⋮ & ⋮ & ⋮ \\ 0 & 0 & 0 & 0 & 0 & 0 & … & 0 & 0 & {a}_{166} & 1 - {a}_{166} & 0 & 0 \\ 0 & 0 & 0 & 0 & 0 & 0 & … & 0 & 0 & {b}_{166} & 1 - {b}_{166} & 0 & 0 \\ 0 & 0 & 0 & 0 & 0 & 0 & … & 0 & 0 & 0 & 0 & {a}_{157} & 1 - {a}_{157} \\ 0 & 0 & 0 & 0 & 0 & 0 & … & 0 & 0 & 0 & 0 & {b}_{157} & 1 - {b}_{157} \\ {a}_{168} & 1 - {a}_{168} & 0 & 0 & 0 & 0 & … & 0 & 0 & 0 & 0 & 0 & 0 \\ {b}_{168} & 1 - {b}_{168} & 0 & 0 & 0 & 0 & … & 0 & 0 & 0 & 0 & 0 & 0\end{matrix} )$$

Here elements aₖ and bₖ can be calculated from historical data. If we assume that the system is in the state (i, j, l) and denote by qₘ columns the probabilities that after m hours the system will be in another respective state, we can then calculate qₘ=P^{m} for all m=1, . . . , 168, where (0, 0, . . . , 1, . . . , 0) is the column with only one nonzero element in the k-th place. Actually qₘ has only two nonzero elements on successive positions. The second position corresponds to checking email after m hours. If we then find the maximal value among second nonzero entries in each qₘ, we can find the number m where this maximum predicts the optimal send time.

Regardless of the class of mathematical model utilized in constructing the ODT algorithm, the purpose of the ODT algorithm remains the same: to treat network metadata accumulated in the presence database in a manner that identifies the time slot(s) in which a particular individual member of a communications network is historically most active on that network, thereby indicating future time slots that are most likely to be optimal for delivering an electronic personal message. In treating the raw data in the presence database with the ODT algorithm, the most useful time divisions may be one week and one hour, i.e. dividing a week into 168 one hour segments, as described above. But there is no fundamental reason why other divisions of time cannot be successfully employed, e.g. dividing a week into half-hour segments, or dividing a day into ten-minute segments, or dividing a year into one day segments.

In a preferred embodiment of the present invention, another algorithm detects whether an intended message recipient is logged-in currently to one or more communication networks, and thus is present to receive a message, and queues the message for immediate sending. The purpose of this “presence algorithm” is to expedite the overall mission of sending an electronic personal message at a time optimal for enhancing the likelihood of open and click-through. If it can be determined that prospective message recipient of interest is currently logged-in to a communication network of interest, then a message can be sent to that individual immediately, thereby obviating the need to predict future optimal time windows and schedule the future sending of the message. The presence algorithm may be coded in the following manner:

If( User.MessageScheduled == true)
{
Message.SendNow( );
}

In a preferred embodiment of the present invention, another algorithm interacts with the communication networks to facilitate scheduled sending of the messages at the optimal time, over specified networks, as predicted by the ODT algorithm. If a prospective message recipient of interest does not appear to be logged-in on any of the communications networks of interest, it is necessary to schedule sending of the message in a future time window identified by the ODT algorithm to be optimal. This “schedule sending” algorithm may be coded in the following manner:

Run ODT Algorithm
Messages = GetMessagesByHour(Now)
CommunicationNetwork.SendAll( Messages )

In a preferred embodiment of the present invention, another algorithm identifies how much traffic was generated based on the effectiveness of the particular network message sent at the optimal time as predicted by the ODT algorithm. For example, if the ODT application of the present invention is used to send a personal electronic message to 100,000 recipients, in each case at the optimal time predicted by the ODT algorithm, it is desirable and instructive to know how many recipients opened the message, and how many of those recipients opening the message actually clicked through it. This “campaign success” algorithm may be coded in the following manner:

Run ODT Algorithm
Messages = GetMessagesByHour(Now)
CommunicationNetwork.SendAll( Messages )
CommunicationNetwork.GetTraffic( )

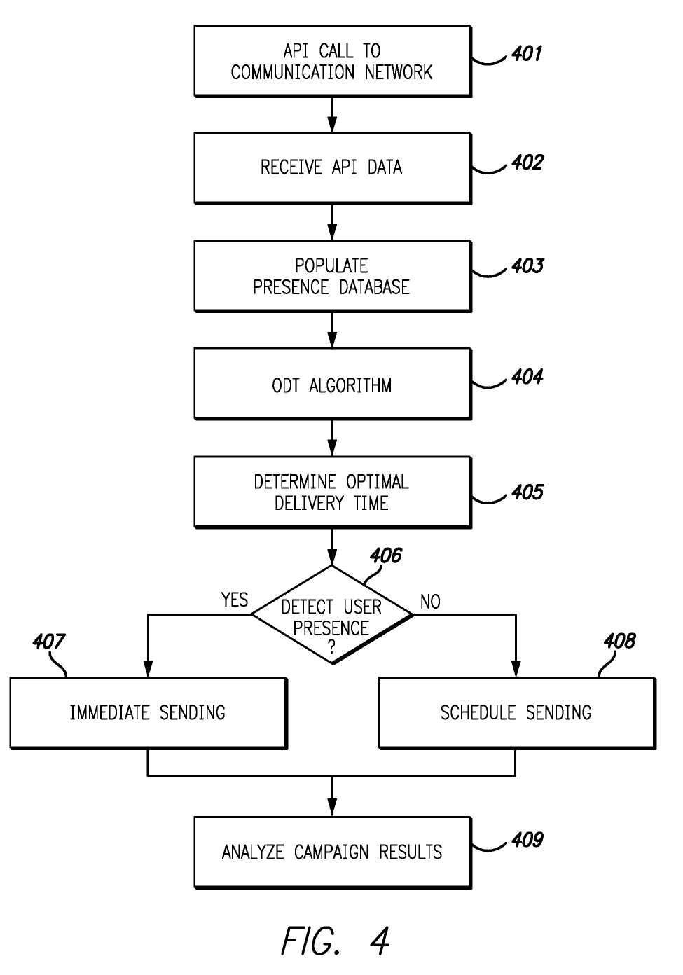

FIG. 4 displays a flow chart of an exemplary method for implementing the present invention. In first step 401, an API call is placed to the administrator or operator of a communication network. The call is initiated from a computing device such as computing device 100, which may take the form of a server, a desktop computer, laptop or notebook computer, or pad. The call can also be initiated from a mobile device such as mobile device 200, which may take the form of a smartphone, pad, or other personal digital assistant. The API call can be placed to an ESP or to a social media network or to any other communication network having an API and having particular individual users that are to be targeted for delivery of an electronic personal message. The API call can proceed from any of the above-listed terminals through the cloud to any desired application programming interface. Data contained in an API library may include, but not be limited to, records of open, click, forward, print, reply, post, and comment events.

In step 402, data is received from an API library, normally via the cloud or internet, and in step 403 the raw data is fed into a presence database. The database could be located locally on computing device 100 or mobile device 200, or it could be located in the cloud on a server maintained by any of a number of commercial purveyors of database solutions. Commercially available databases include, but are not limited to, Microsoft's SQL Azure database, Salesforce.com's Database.com, Xeround's MySQL database, Amazon's NoSQL SimpleDB, Google's AppEngine and related products, ClearDB, and CouchOne's NoSQL CouchDB.

In step 404, data in the presence database is processed through an ODT algorithm that determines optimal delivery time for an electronic personal message based on the historical computing habits of the intended recipient. The output of the algorithm indicates at step 405 the best future time-slots for sending a message to each recipient in the presence database.

At step 406, a presence algorithm engages with the communication networks of interest to determine whether a particular individual network user is currently logged-in. Here the process bifurcates. If the intended recipient is logged-in and present, at step 407 the personal electronic message is immediately queued for sending. If the intended recipient is not logged-in, at step 408 a schedule sending algorithm engages with the communication network to schedule sending of the message at a future time-slot determined in step 405.

Finally, at step 409, a campaign success algorithm analyzes the results of the message campaign to determine its success. The number of open, click, forward, print, reply, post, or comment events generated by the campaign is noted and compared with results of prior campaigns.

The above specification, examples and data provide a complete description of the manufacture and use of the invention. However, many embodiments of the invention can be made without departing from the spirit and scope of the invention.

What is claimed is:

1) A computer-implemented method of determining optimal delivery time of an electronic personal message, comprising:
placing one or more application programming interface calls to the administrator of a communication network to obtain network timestamp data, including log-in and log-out information, over multi-day time periods for particular individual members of the communication network;
preparing a presence database by compiling the log-in and log-out information for the members of the communication network;
processing the information in the presence database through an algorithm that identifies one or more time-slots of maximal activity on the communication network for each particular individual member of the communication network; and
determining for each particular individual member of the communication network, based on the output of the algorithm, the future time-slots when that member is most likely to be logged-in to the communication network.

2) The computer-implemented method of claim 1, wherein the algorithm assigns a multiplier to primary time-slots of maximal activity on the network, assigns a smaller multiplier to adjoining secondary time-slots on either side of the primary time-slots of maximal activity, and sums the products of the respective multipliers and primary and adjoining secondary time-slots.

3) The computer-implemented method of claim 1, wherein the algorithm comprises a wavelet transform model.

4) The computer-implemented method of claim 1, wherein the algorithm comprises a Poisson generalized linear regression model.

5) The computer-implemented method of claim 1, wherein the algorithm comprises a Markov model.

6) The computer-implemented method of claim 1, wherein the communication network comprises an email service provider.

7) The computer-implemented method of claim 1, wherein the communication network comprises a social media network.

8) A computer-implemented method of delivering an electronic personal message at the optimal times for enhancing its likelihood of open and click-through, comprising:
placing one or more application programming interface (API) calls to the administrator of a communication network to obtain network timestamp data, including log-in and log-out information, over multi-day time periods for the members of the communication network;
preparing a presence database by compiling and periodically updating the log-in and log-out information for the particular individual members of the communication network;
processing the information in the presence database through a first algorithm that identifies one or more time-slots of maximal activity on the communication network for each particular individual member of the communication network;
determining for each particular individual member of the communication network, based on the output of the first algorithm, the future time-slots when that member is most likely to be logged-in to the communication network; and
placing an API call to the administrator of the communication network to schedule, using a second algorithm, the sending of one or more electronic personal messages to particular individual members of the communication network at predicted future time-slots when those members are most likely to be logged-in to the communication network.

9) The computer-implemented method of claim 8, wherein the first algorithm assigns a multiplier to primary time-slots of maximal activity on the network, assigns a smaller multiplier to adjoining secondary time-slots on either side of the primary time-slots of maximal activity, and sums the products of the respective multipliers and primary and adjoining secondary time-slots.

10) The computer-implemented method of claim 8, wherein the first algorithm comprises a wavelet transform model.

11) The computer-implemented method of claim 8, wherein the first algorithm comprises a Poisson generalized linear regression model.

12) The computer-implemented method of claim 8, wherein the first algorithm comprises a Markov model.

13) The computer-implemented method of claim 8, wherein the communication network comprises an email service provider.

14) The computer-implemented method of claim 9, wherein the communication network comprises a social media network.

15) The computer-implemented method of claim 9, wherein an API call placed to the administrator of the communication network detects, using a third algorithm, whether one or more particular individual members of the communication network are logged-in to the network and, if any members are logged-in, immediately sends them one or more electronic personal messages.

16) The computer-implemented method of claim 9, wherein an API call is placed to the administrator of the communication network to obtain and process, using a fourth algorithm, open and click-through data for the electronic personal messages sent to particular individual members of the communication network, to determine whether open and click-through rates have been enhanced.

17) A system for delivering an electronic personal message at the optimal times for enhancing likelihood of open and click-through of the message, comprising:
a computing device that includes an optimal delivery-time application and a database, the optimal delivery-time application being configured to:
place one or more application programming interface (API) calls to the administrator of a communication network to obtain network timestamp data, including log-in and log-out information, over multi-day time periods for particular individual members of the communication network;
prepare a presence database by compiling and periodically updating the log-in and log-out information for the particular individual members of the communication network;
process the information in the presence database through a first algorithm that identifies one or more time-slots of maximal activity on the communication network for each particular individual member of the communication network;
determine for each particular individual member of the communication network, based on the output of the first algorithm, the future time-slots when that member is most likely to be logged-in to the communication network;
schedule, using a second algorithm, the sending of one or more electronic personal messages to particular individual members of the communication network at predicted future time-slots when those members are most likely to be logged-in to the communication network;
place an API call to the administrator of the communication network to detect, using a third algorithm, whether one or more particular individual members of the communication network are logged-in to the network and, if any members are logged-in, immediately send them one or more electronic personal messages; and
place an API call to the administrator of the communication network to obtain and process, using a fourth algorithm, open and click-through data for the electronic personal messages sent to particular individual members of the communication network, to determine whether open and click-through rates have been enhanced.

18) The system of claim 17, wherein the first algorithm assigns a multiplier to primary time-slots of maximal activity on the network, assigns a smaller multiplier to adjoining secondary time-slots on either side of the primary time-slots of maximal activity, and sums the products of the respective multipliers and primary and adjoining secondary time-slots

19) The system of claim 17, wherein the communication network comprises an email service provider.

20) The system of claim 17, wherein the communication network comprises a social media network.
